(19) United States
(12) Patent Application Publication
(10) Pub. No.: US 2008/0126761 A1
(43) Pub. Date: May 29, 2008

(54) METHOD AND APPARATUS FOR SCHEDULING OPTIMIZATION

(76) Inventors: Nathan D. Fontenot, Cedar Park, TX (US); Joel Howard Schopp, Austin, TX (US); Michael Thomas Strosaker, Austin, TX (US); Linda Ping Xie, Austin, TX (US)

Correspondence Address: IBM CORP (YA);C/O YEE & ASSOCIATES PC, P.O. BOX 802333, DALLAS, TX, 75380, US

(21) Appl. No.: 11/535,136

(22) Filed: Sep. 26, 2006

(51) Int. Cl. G06F 9/315

(52) U.S. Cl. 712/225; 712/E09.034

(57) ABSTRACT

A computer implemented method, data processing system, and a computer program product for improving the scheduling of system processes by the central processing unit. The process retrieves a set of profiling data from an executable object file for the application. The set of profiling data is associated with a given process of the application. The process passes the set of profiling data to a scheduler. The scheduler uses the set of profiling data for scheduling the given process for execution by a processor.

### BACKGROUND OF THE INVENTION

1. Field of the Invention

The present application is related generally to a data processing system and in particular to a method and apparatus for scheduling processes. More particularly, the present application is directed to a computer implemented method, apparatus, and computer usable program code for providing a set of profiling data to a scheduler to assist in scheduling of processes for execution.

2. Description of the Related Art

A multitasking operating system is an operating system that switches between executions of processes to give the appearance of multiple processes executing concurrently or simultaneously on a single processor. A processor, such as a central processing unit (CPU), interprets instructions and processes data contained in computer programs. As used herein, a process is a running instance of a program, a task, thread, or other item of work to be performed by a processor. The term “running” refers to a processor actively executing the instructions of a process. However, only one process is actually executing at any given time on a given processor thread.

Scheduling is an important feature in computer multitasking, multiprocessing operating system design, and in real-time operating system design. Scheduling refers to the assignment of priorities to processes waiting to be executed by a processor. The scheduling of processes is carried out by software known as a scheduler.

During multitasking, a scheduler schedules which process will be the one process executing on the processor and how much time that process will be allowed to utilize the processor for execution. The scheduler also schedules which process waiting to be executed will be the next process to run on the processor. Thus, the scheduler determines which processes are given priority for execution by the processor.

In general, the goal of the scheduler is to balance processor loads to prevent any given process from either monopolizing the processor or failing to obtain access to the processor. A scheduler utilizes a scheduling algorithm to allocate processor time to processes. Scheduling algorithms are used to effectively optimize resource utilization and decrease computing time.

Most modern schedulers consider several factors when choosing which process will be given the next allotment of processor time. One of these factors is the behavior of each process with regard to system resources such as memory, I/O and computational intensity. For example, a process that is I/O intensive may be given a higher priority for obtaining processor time because there is a good chance that the process will not use its full allotment of processor time and will cede the processor to another process quickly.

The performance of a process during run time is useful in making scheduling decisions. However, the scheduler requires time to gather the run time performance data into a useful data set for scheduling purposes. Thus, there is frequently a latency period between the time at which a process begins executing on a process and the time at which the scheduler has gathered a useable set of profiling data regarding the executing process for use in scheduling. In some cases, this latency period is so long that the execution of the process will be completed before enough data is gathered by the scheduler to be useful in making scheduling decisions. In addition, the run time data set is generally not saved by the scheduler. Therefore, the run time data that is gathered by the scheduler for a process during execution of the process is lost when the process ends.

### SUMMARY OF THE INVENTION

The aspects of the illustrative embodiments provide a computer implemented method, apparatus, and a computer program product for improving the scheduling of system processes by the central processing unit. The loader retrieves a set of profiling data from an executable object file for the application. The set of profiling data is associated with a given process of the application. The loader passes the set of profiling data to a scheduler. The scheduler uses the set of profiling data for scheduling the given process for execution by a processor.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which the illustrative embodiments may be implemented in accordance with a preferred embodiment of the present invention;

FIG. 2 is a block diagram of a data processing system shown in which the illustrative embodiments may be implemented;

FIG. 3 is a block diagram illustrating a dataflow when a set of profiling data is provided to a scheduler in accordance with an illustrative embodiment;

FIG. 4 is a block diagram illustrating the process of generating an application executable file containing profiling data for an application stored as meta-data in accordance with an illustrative embodiment;

FIG. 5 is a sequence diagram illustrating a process for passing profiling data to the scheduler in accordance with an illustrative embodiment;

FIG. 6 is a flowchart illustrating a process for generating an initial set of profiling data for an application in accordance with an illustrative embodiment;

FIG. 7 is a flowchart illustrating a process for sending a set of profiling data to a scheduler in accordance with an illustrative embodiment; and

FIG. 8 is a flowchart illustrating a process for using a set of profiling data for scheduling processes and generating an updated set of profiling data in accordance with an illustrative embodiment.

### DETAILED DESCRIPTION OF THE PREFERRED EMBODIMENT

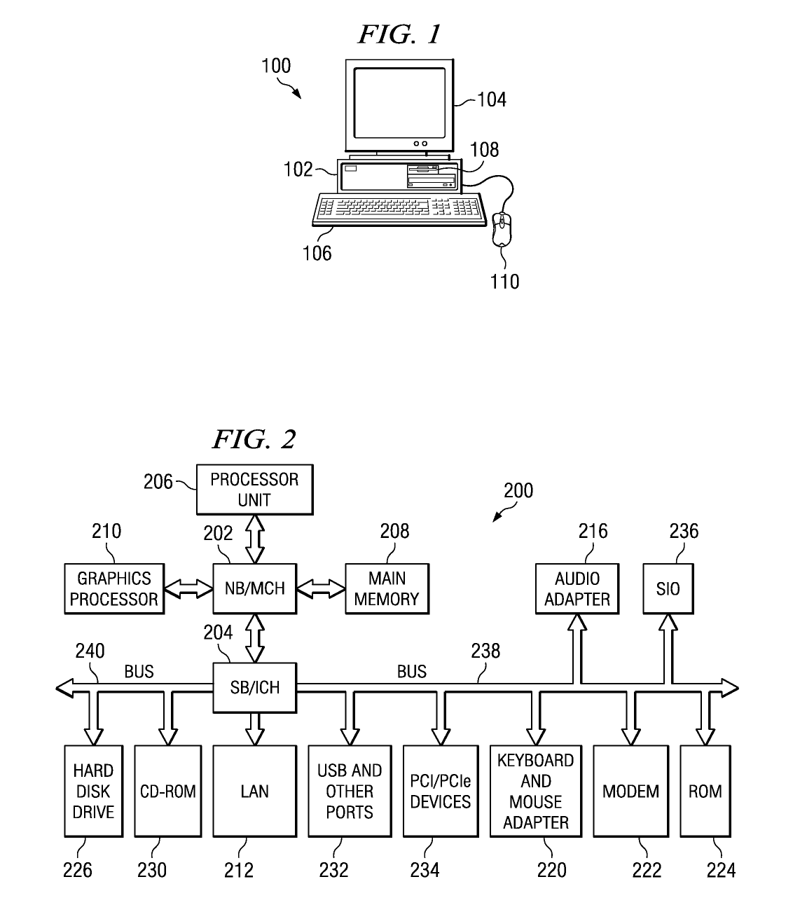

With reference now to the figures and in particular with reference to FIG. 1, a pictorial representation of a data processing system in which the illustrative embodiments may be implemented. Computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer computer or IntelliStation computer, which are products of International Business Machines Corporation, located in Armonk, N.Y. Although the depicted representation shows a computer, other embodiments of the illustrative embodiments may be implemented in other types of data processing systems, such as a network computer. Computer 100 also preferably includes a graphical user interface (GUI) that may be implemented by means of systems software residing in computer readable media in operation within computer 100.

Next, FIG. 2 depicts a block diagram of a data processing system in which illustrative embodiments may be implemented. Data processing system 200 is an example of a computer, such as computer 100 in FIG. 1, in which code or instructions implementing the processes of the illustrative embodiments may be located.

In the depicted example, data processing system 200 employs a hub architecture including a north bridge and memory controller hub (MCH) 202 and a south bridge and input/output (I/O) controller hub (ICH) 204. Processor 206, main memory 208, and graphics processor 210 are coupled to north bridge and memory controller hub 202. Graphics processor 210 may be coupled to the MCH through an accelerated graphics port (AGP), for example.

In the depicted example, local area network (LAN) adapter 212 is coupled to south bridge and I/O controller hub 204, audio adapter 216, keyboard and mouse adapter 220, modem 222, read only memory (ROM) 224, universal serial bus (USB) ports, and other communications ports 232. PCI/PCIe devices 234 are coupled to south bridge and I/O controller hub 204 through bus 238. Hard disk drive (HDD) 226 and CD-ROM drive 230 are coupled to south bridge and I/O controller hub 204 through bus 240.

PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processor 206. This operating system coordinates and controls various components within data processing system 200 in FIG. 2. The operating system may be a commercially available operating system, such as Microsoft® Windows XP®. (Microsoft® and Windows XP® are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java-based trademarks are trademarks of Sun Microsystems, Inc. in the United States, other countries, or both.

Instructions for the operating system, the object-oriented programming system, and applications or programs are located on storage devices, such as hard disk drive 226. These instructions may be loaded into main memory 208 for execution by processor 206. The processes of the illustrative embodiments may be performed by processor 206 using computer implemented instructions, which may be located in a memory. An example of a memory is main memory 208, read only memory 224, or in one or more peripheral devices.

The hardware shown in FIG. 1 and FIG. 2 may vary depending on the implementation of the illustrated embodiments. Other internal hardware or peripheral devices, such as flash memory, equivalent non-volatile memory, or optical disk drives and the like, may be used in addition to or in place of the hardware depicted in FIG. 1 and FIG. 2. Additionally, the processes of the illustrative embodiments may be applied to a multiprocessor data processing system.

The systems and components shown in FIG. 2 can be varied from the illustrative examples shown. In some illustrative examples, data processing system 200 may be a personal digital assistant (PDA). A personal digital assistant generally is configured with flash memory to provide a non-volatile memory for storing operating system files and/or user-generated data. Additionally, data processing system 200 can be a tablet computer, laptop computer, or telephone device.

Other components shown in FIG. 2 can be varied from the illustrative examples shown. For example, a bus system may be comprised of one or more buses, such as a system bus, an I/O bus, and a PCI bus. Of course the bus system may be implemented using any suitable type of communications fabric or architecture that provides for a transfer of data between different components or devices attached to the fabric or architecture.

Additionally, a communications unit may include one or more devices used to transmit and receive data, such as a modem or a network adapter. Further, a memory may be, for example, main memory 208 or a cache such as found in north bridge and memory controller hub 202. Also, a processing unit may include one or more processors.

The depicted examples in FIG. 1 and FIG. 2 are not meant to imply architectural limitations. In addition, the illustrative embodiments provide for a computer implemented method, apparatus, and computer usable program code for compiling source code and for executing code. The methods described with respect to the depicted embodiments may be performed in a data processing system, such as data processing system 100 shown in FIG. 1 or data processing system 200 shown in FIG. 2.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the illustrative embodiments may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a web appliance.

The processes of the illustrative embodiments are performed by processor 202 using computer implemented instructions, which may be located in a memory such as, for example, main memory 208, memory 224, or in one or more peripheral devices 226-230.

A process is a running instance of a program. Because only one process can be executing at any one time per processor thread, a multitasking operating system may switch between processes to give the appearance of many processes executing concurrently or simultaneously. This is usually done to effectively optimize resource utilization and decrease computing time.

Assigning a priority to a process is carried out by software known as a scheduler. A process' priority determines when the process will run. In other words, the process' priority determines when the process is given access to the processor. Most modern schedulers consider several factors when determining the priority of a process. One of these factors is the behavior of each process with regard to system resources such as memory, I/O and computational intensity. As an example, a process that is I/O intensive may be given a higher priority for getting processor time because there is a good chance that the process will not use its full allotment of processor time. In such a case, the process will cede processor time to another process quickly.

Therefore, having a dataset of a process' behavior is useful to the scheduler in making scheduling decisions. The dataset of a process' behavior during execution is referred to herein as profiling data. As used herein, profiling data refers to a set of data describing the attributes of a process during execution, the resource requirements of the process, and/or any other data regarding the execution and processing performance of a given process.

In current systems, some schedulers gather profiling data on a process' behavior during the time the process is given access to the processor. However, not all currently available schedulers gather profiling data. Therefore, the initial scheduling of the process by the scheduler is performed without the aid of a process' profiling dataset prior to execution of the process.

In addition, the scheduler requires time to gather the process' behavior into a useful dataset. Therefore a latency period generally occurs between the time that a process begins running and the time that the scheduler generates the profiling data for the process.

The illustrative embodiments recognize that this latency period can result in problems because a process will often finish processing before enough data is gathered to be useful in making scheduling decisions. In addition, current schedulers do not save or preserve the profiling data for a process. Thus, another problem is that the profiling dataset built up by the scheduler for a process is lost when the process cedes the processor and/or completes execution.

The aspects of the illustrated embodiments recognize the advantages of providing the scheduler with the profiling dataset of a process' behavior prior to the initial scheduling of the process. Thus the illustrative embodiments are directed to a computer implemented method, apparatus, and a computer program product for generating profiling data and providing the profiling data to a scheduler.

In accordance with the illustrative embodiments, a set of profiling data is generated for an application prior to execution of the application. In one illustrative example, the set of profiling data is generated by a compiler during compile time of the application. Compiling refers to converting source code into object code.

In another illustrative example, the set of profiling data is generated by a linker during the link phase of building the application. The link phase of an application refers to a phase during the compiling process of an application. During the linking phase, the linker takes one or more objects generated by the compiler and assembles them into a single executable program.

The linker generates the set of profiling data during the link phase of building the application by making an additional pass on the executable code stored in the text section of an object file. The linker stores a set of profiling data as meta-data in the executable object file for the application. In this illustrative example, the set of profiling data includes process attributes such as memory or I/O usage and computational intensity. As used herein, an executable object file is an executable file for an application that is ready for execution on a computer.

The scheduler might use this profiling data to determine when a process will execute and how long the process will be allowed to execute on the processor. For example, a process with greater input/output usage would likely require less processor time while a process with greater computational intensity might require more processor time. Therefore, the input/output intensive process would be scheduled to execute first and the computationally intensive process might be scheduled to process last to take advantage of the different resource requirements of the processes. Thus, each process has a unique set of profiling data. However, in accordance with this illustrative embodiment, the scheduler may look at profiling data for multiple processes when making a scheduling decision regarding a single process.

When the application runs, the loader retrieves the set of profiling data from the executable object file for the application. The set of profiling data is associated with a given process that is to be executed by a processor. The loader passes the set of profiling data to a scheduler. The scheduler uses the set of profiling data for scheduling the given process for execution by the processor. In this illustrative example, the action of retrieving and passing the set of profiling data to the scheduler is performed by the operating system kernel.

The illustrative embodiments also update the set of profiling data during the life of the given process. During execution of the process and/or after execution of the process has completed, the scheduler gathers profiling data regarding the behavior of the process. The scheduler uses this profiling data to update the set of profiling data. The scheduler sends the updated set of profiling data to the loader. In another illustrative example, the loader pulls the profiling data from the scheduler.

In the illustrative example, the scheduler uses the updated set of profiling data to modify the schedule for the execution of the given process. Thus, in this example, the scheduler is able to dynamically update the scheduling of a given process based on data generated during execution of the process at run time of the application.

As discussed above, the scheduler performs an analysis of execution performance on processes as they execute. The scheduler can then modify or update the initial profiling dataset to refine the profiling data for further use in scheduling. In this manner, the more often a process runs the more accurate and fined tuned the data becomes.

In accordance with another embodiment, profiling data for executing code can be gathered by software tools other than the scheduler. These software profiling tools gather profiling data during execution of a process and provide the profiling data to the scheduler for use in scheduling. These software profiling tools also provide the profiling data to the loader to be saved by the loader as meta-data in the application executable object file.

The illustrated embodiments further recognize the advantages of storing the updated dataset for a process when the process cedes. After the scheduler generates the updated set of profiling data, the loader saves the updated set of profiling data as meta-data in the executable object file for the application after the process cedes. As used herein, cedeing the processor means the process no longer has access to the processor. A process will cede the processor for several reasons. For example, a process can cede the processor because the process has been preempted by another process that has a higher priority. A process can also cede the processor when the process finishes execution.

The illustrative embodiments also recognize the advantages of storing the dataset when a process cedes the processor so that the profiling dataset is not lost when the process leaves the processor.

Accordingly, the illustrative embodiments are directed to a computer implemented method, apparatus, and a computer program product for updating the profiling data during the life of the process by the analysis tools of the scheduler and storing the updated profiling data as meta-data in the object file of the application.

In accordance with another illustrative embodiment, the process retrieves meta data from an executable object file for an application. The meta data contains data about the application. The meta data is generated by a linker during a link phase of building the application. The process passes the meta data to a scheduler, wherein the scheduler uses the meta data for scheduling the given process for execution by a processor. The process updates the meta data during the life of the process to form an updated meta data.

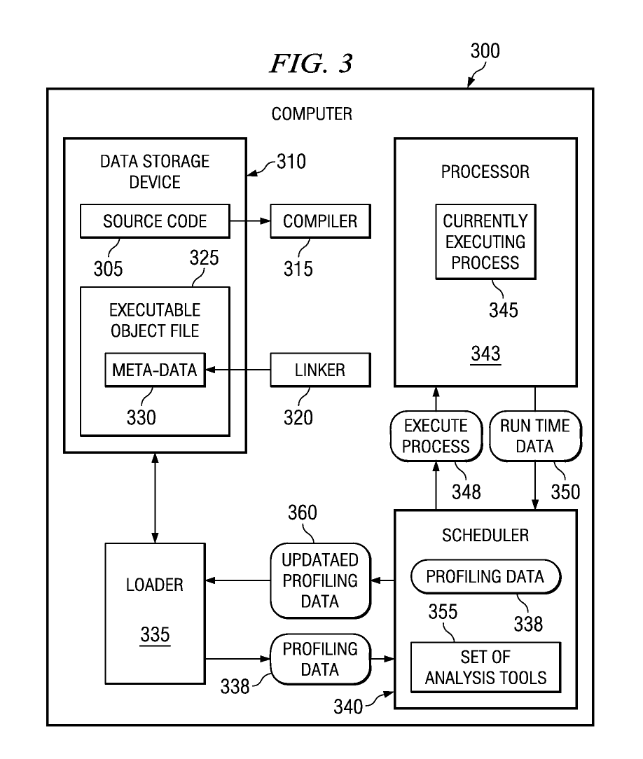

FIG. 3 is a block diagram illustrating a dataflow when a set of profiling data is provided to a scheduler in accordance with an illustrative embodiment. Computer 300 is any type of computing device, such as a personal computer, laptop, personal digital assistant, or any other computing device depicted in FIGS. 1 and 2.

In these illustrative examples, source code 305 is any known or available source code for computer application software for use on computer 300 to perform one or more tasks. Loader 335 loads source code 305 onto computer 300 and stores source code 305 on a data storage device, such as data storage device 310. Data storage device 310 is any known or available device for storing programs and data, including but not limited to, a hard disk, a floppy disk, a flash memory, an optical disk storage, or any data storage device. In this illustrative example, data storage device 310 is a data storage device such as hard disk drive 226, CD-ROM 230, or ROM 224 in FIG. 2.

Compiler 315 compiles source code 305 for execution on computer 300. Compiler 315 is a software component that translates a program, such as source code 305, written in a source code into object code. Source code is generally written in a language that is easier for humans to understand. Examples of programming languages include C programming language, C++ programming language, Java, Fortran, Pascal, or any other programming languages.

Compiler 315 generates object code that a machine, such as computer 300, can understand. The object code can be linked to other object files to generate an executable file, such as executable object file 325.

During the linking phase, linker 320 creates a set of profiling data based on the object code for source code 305. Linker 320 is a software component that links an object file to one or more library files to form an executable file, such as executable object file 325. Linker 320 performs a second pass through the object code for source code 305 during the linking phase to gather data from the object code for generating a set of profiling data. Linker 320 then saves the set of profiling data in a separate portion of the executable object file 325 as meta-data 330.

Loader 335 is a software program that prepares executable object file 325 for execution. Loader 335 retrieves the set of profiling data, such as profiling data 338 from executable object file 325 in data storage device 310. Loader 335 then sends profiling data 338 to scheduler 340.

In accordance with another illustrative embodiment, loader 335 generates profiling data, rather than linker 320. In this example, loader 335 sends the profiling data generated by loader 335 to scheduler 340.

Scheduler 340 uses profiling data 338 to schedule the given process. Profiling data 338 is the set of profiling data that provides data regarding the behavior of a given process during execution of the process. In this illustrative example, profiling data 338 includes data regarding process attributes such as memory or I/O usage and computational intensity.

Scheduler 340 triggers execution of a process scheduled for execution on processor 343 after currently executing process 345 has ceded the processor 343. Processor 343 is a processor such as processor unit 206 in FIG. 2. Processor 343 is any type of known or available processor for executing a process on computer 300, including but not limited to, a central processing unit (CPU) or a digital signal processor (DSP).

Currently executing process 345 is a currently running instance of a program executing on processor 343. When currently executing process 345 cedes the processor, scheduler 340 sends an execute process 348 signal to trigger execution of the next process scheduled for execution. That process then becomes currently executing process 345.

During execution of currently executing process 345, scheduler 340 gathers run time data 350. Run time data 350 is data regarding the behavior of currently executing process 345. Scheduler 340 uses set of analysis tools 355 to analyze run time data 350. Scheduler 340 uses the results of the analysis of run time data 350 to update profiling data 338 to form updated profiling data 360.

Updated profiling data 360 is a set of profiling data that has been updated or modified by scheduler based on run time data 350. Scheduler 340 utilizes updated profiling data 360 to modify or update the schedule for execution of currently executing process 345.

Thus, in this illustrative embodiment, scheduler 340 modifies the schedule for executing a given process based on data regarding the performance of the process during execution and the resource requirements of the process. In this manner, scheduler 340 uses updated profiling data 360 to make intelligent scheduling decisions for currently executing process 345.

Scheduler 340 sends updated profiling data 360 to loader 335. Loader 345 saves updated profiling data 360 as meta-data 330 in executable object file 325.

In accordance with another illustrative embodiment, scheduler 340 updates profiling data 338 after a process has ceded processor 343 based on run time data 350 gathered during execution of the process. In accordance with this example, scheduler 340 waits until a process cedes the processor to update profiling data.

In another example, scheduler 340 performs a first update of profiling data 338 during execution of a process to generate updated profiling data 360. Scheduler 340 then performs a second update of updated profiling data 360 after the process cedes processor 343 based on all the run time data gathered throughout execution of the process. Thus, in this example, profiling data can be updated multiple times as the process executes. The updated profiling data can then be updated again when the process cedes processor 343.

In this illustrative embodiment, the initial set of profiling data is generated by linker 320 during the link phase of building the application. Linker 320 generates the profiling data by making an additional pass on the executable code stored in the text section of an object file. In another illustrative example, the initial set of profiling data is generated by compiler 315 during compile time. In this example, linker 320 gathers all of the resulting profiling data from compiler 315 as a set of profiling data. Linker 320 then saves the set of profiling data as meta-data 330 in executable object file 325.

However, generating an initial set of profiling data by compiler 315 and/or linker 320 is not required. For example, the initial set of profiling data can be generated by scheduler 340 during execution of a process, such as currently executing process 345. This set of profiling data is saved as meta data in the application executable object file for the next time the process is executed. In this manner, the set of profiling data is generated and saved during execution of the process rather than during compile time or the linking phase.

In this example, loader 335 retrieves profiling data 338 from executable object file 325. However, any part of the operating system kernel can retrieve profiling data 338 from meta-data 330 and provide profiling data 338 to scheduler 340 in accordance with the illustrative embodiments.

Likewise, in this example, scheduler 340 analyzes run time data 350 during the execution of currently executing process 348 to generate updated profiling data 360. However, a separate profiling component can also be utilized to gather and analyze run time data 345 and generate updated profiling data 360. The profiling component can be any type of software component for analyzing run time data to generate profiling data. The profiling components can be associated with scheduler 340 or the profiling component can be an entirely separate component from scheduler 340.

In accordance with another illustrative embodiment, each time a currently executing process cedes processor 343, all profiling data, such as updated profiling data 360, is written back to executable object file 325 as meta-data 330. Loader 335 or any other component of the operating system kernel can perform the write back of updated profiling data 360 to executable object file 325 after a process cedes processor 343.

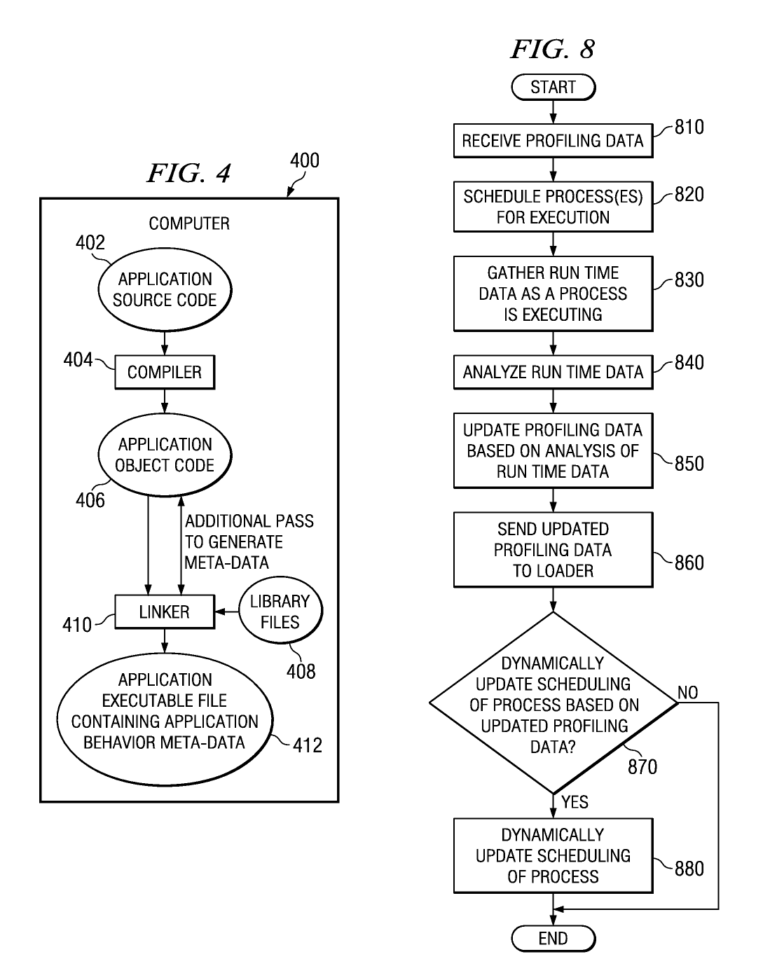

With reference now to FIG. 4, a block diagram illustrating the process of generating an application executable file containing profiling data for an application stored as meta-data in accordance with an illustrative embodiment. Computer 400 is an example of a computer, such as computer 100 in FIG. 1, in which code or instructions implementing the processes of the illustrative embodiments may be located. Computer 400 illustrates the method of generating an application executable file containing profiling data regarding the application's process behavior 412. The application's process behavior is stored as meta-data in a separate section of the application's executable object file.

Computer 400 contains the source code of application 402. Source code is any series of statements written in some human-readable computer programming language. Examples of computer programming languages may include C, C++, Java, and Fortran. Source code is compiled to create an executable program file. An executable file is a file whose contents are capable of being interpreted as a program and executed by computer 400. Most often, an executable file contains the binary representation of machine instructions for specific processors.

Compiler 404 is a computer program, or set of programs, that translates text written in a computer language, which is the source language, into another computer language which is the target language. The original sequence is referred to as the source code 402. The output is referred to as object code 406. Commonly the object code has a form suitable for processing by other programs (e.g., a linker 410), but the object code can also include a human readable text file.

Library files 408 is a collection of subprograms used to develop software. Library files 408 contains modular “helper” code and data written by other programs and saved in library files 408 for use by other programs. Library files 408 allow code and data to be shared and changed in a modular fashion. Executables make references to libraries through links. An executable links to libraries through a process known as linking, which is typically done by a linker 410.

Linker 410 is a program, such as linker 320 in FIG. 3. Linker 410 takes one or more objects generated by compiler 404 and assembles the objects into a single executable program 412. The job of linker 410 is to resolve references to undefined symbols by finding out which other object defines a symbol in question, and replacing placeholders with the symbol's address. Linkers can take objects from a collection of library files, such as library files 408.

In this illustrated embodiment, when an object file is built, linker 410 makes an additional pass on the executable code stored in the text section of the object file. This initial analysis of the applications behavior determines attributes such as memory or I/O usage and computational intensity from the executable code. The data gathered is stored as meta-data in a separate section of the application's executable object file 412.

The depicted example in FIG. 4 and is not meant to imply architectural limitations. For example, data processing system 400 may employ an interpreter. An interpreter is a computer program that executes other programs. This is in contrast to a compiler which does not execute its input program (the source code) but translates the input program into another language, usually an executable machine code, also referred to as object code. Object code is output to a file that is ready for later execution by computer 400. It may be possible to execute the same source code either directly by an interpreter or by compiling it and then executing the machine code produced.

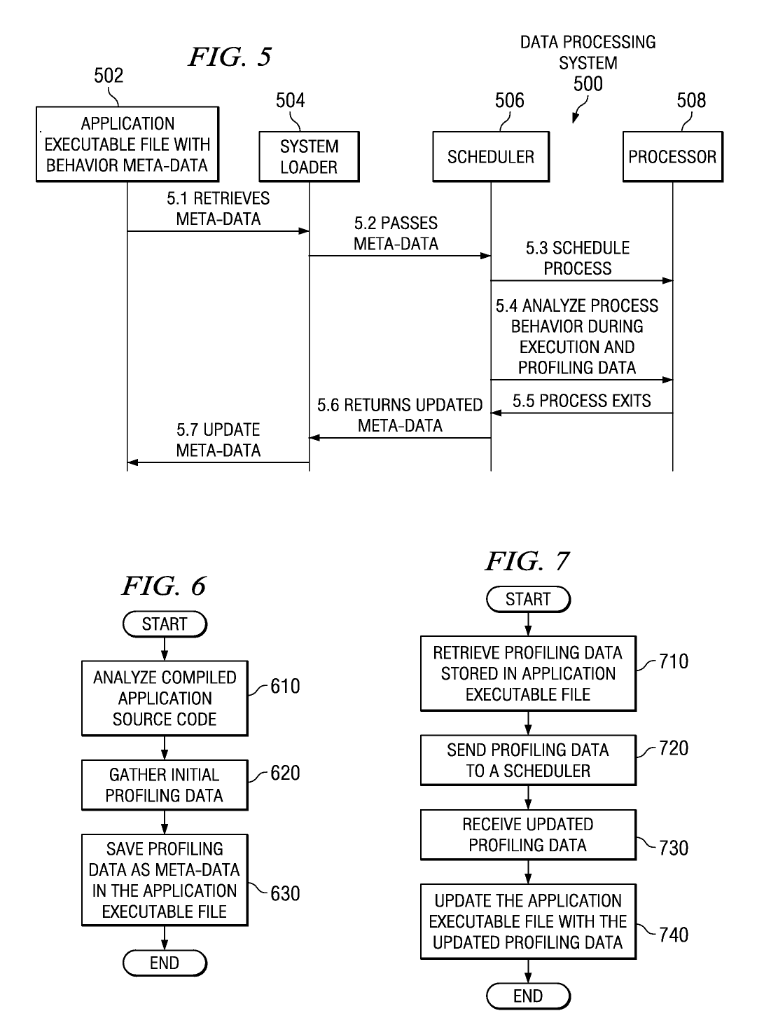

Next, FIG. 5 is a sequence diagram illustrating a process for passing profiling data to the scheduler in accordance with an illustrative embodiment. Profiling data is used by the scheduler for scheduling a process. The scheduler also updates the profiling data after execution of the process is complete. The profiling data is stored as meta data in a separate section of the application's executable object file.

Data processing system 500 is an example of a computer, such as computer 100 in FIG. 1, in which code or instructions implementing the processes of the illustrative embodiments may be located.

Data processing system 500 contains application executable file which includes behavior meta-data 502, such as the application executable file 412 in FIG. 4. The behavior meta-data is a set of profiling data regarding the process' behavior. When the application is executed, the meta-data stored in the application's executable object file is retrieved (message 5.1) by the system loader 504. System loader 504 passes the meta-data (message 5.2) to scheduler 506. Scheduler 506 uses the meta-data of the process' behavior to schedule a process (message 5.3).

During execution of the process, that is, during the time the process is allocated time from processor 508 time, scheduler 506 will update the profiling data during the life of the process based on an analysis of run time data for the process (message 5.4). The scheduler uses analysis tools to analyze the run time data.

When the process cedes processor 508 (message 5.5), scheduler 506 returns the updated meta-data (message 5.6) to system loader 504. System loader 504 updates the meta-data (message 5.7) stored in the object file of the application 502.

Turning now to FIG. 6, a flowchart illustrating a process for generating an initial set of profiling data for an application is depicted in accordance with an illustrative embodiment. In the illustrative example of FIG. 6, the process is implemented by a software component, such as linker 320 in FIG. 3. In accordance with this illustrative example, steps 610 and 620 can also be performed by compiler 315 in FIG. 3.

The process begins by analyzing the compiled source code for an application (step 610). This step can be performed by a compiler during compile time or by a linker during the linking phase. The process gathers initial profiling data based on the analysis of the code for the application (step 620). The initial profiling data is a set of profiling data regarding a given process to be executed by a processor. The process saves the profiling data as meta-data in the application executable file (step 630) with the process terminating thereafter.

In accordance with the illustrative embodiments, the initial profiling data can be updated during execution of a given process to form updated profiling data. The profiling data can also be updated after the process has ceded the processor and/or completed processing on the processor to form updated profiling data.

FIG. 7 is a flowchart illustrating a process for sending a set of profiling data to a scheduler in accordance with an illustrative embodiment. In this illustrative example in FIG. 7, the process is implemented by a software component of the operating system kernel, such as loader 335 in FIG. 3.

The loader begins by retrieving profiling data stored as meta-data in the application executable file (step 710). The loader sends the profiling data to a scheduler (step 720) for use in scheduling a process for execution by a processor.

The loader receives updated profiling data (step 730) from the scheduler or from a software profiling tool. The loader saves the updated profiling data by updating or writing back to the application executable file with the updated profiling data (step 740) with the process terminating thereafter.

Referring now to FIG. 8, a flowchart illustrating a process for using a set of profiling data for scheduling a process and generating an updated set of profiling data is depicted in accordance with an illustrative embodiment. In this illustrative example in FIG. 8, the process is implemented by a software component, such as scheduler 340 in FIG. 3.

The scheduler begins by receiving profiling data (step 810) from a loader. The scheduler schedules a process for execution on a processor (step 820). The scheduler gathers run time data as a process is executing (step 830). The scheduler analyzes the run time data (step 840). The scheduler then updates the profiling data based on the results of the analysis of the run time data (step 850). The scheduler sends the updated profiling data to the loader (step 860).

The scheduler makes a determination as to whether to dynamically update the scheduling of the currently running process based on the updated profiling data (step 870). If the scheduler determines that the scheduling should not be updated, the process terminates thereafter. For example, if a process terminated abnormally, the profiling data gathered during execution of the process could be considered corrupted. In such a case, the updated profiling data would be unusable. In such a case, the scheduler could make a determination that profiling data should not be updated.

If the scheduler determines that the scheduling should be updated, the scheduler dynamically updates the scheduling of the process (step 880) based on the updated profiling data, with the process terminating thereafter.

Thus, the illustrative embodiments provide for a computer implemented method, apparatus, and computer program product for providing profiling data associated with a given process of an application to a scheduler. The scheduler uses the profiling data to schedule the process for execution on a processor based on the profiling data.

The profiling data is saved as meta data in an executable object file for the application. In this manner, data regarding the behavior of a process is always available to the scheduler to assist in the scheduling of the process. In addition, the profiling data is updateable by a user and/or by the scheduler or another software components for updating profiling data. This provides the additional advantage of permitting the updated profiling data to reflect the performance of a process as it executes on the processor. Thus, the profiling data can be updated during execution of the process, or after the process cedes the processor based on the data generated regarding the process' performance during the execution of the process.

The illustrative embodiments further provide for storing profiling data as meta data in the executable object file for the application after the process has ceded the processor and/or completed execution so that the profiling data will be available to the scheduler the next time the process is scheduled for execution. Thus, the process does not have to re-generate the profiling data because the profiling data is preserved after the process cedes the processor.

The flowchart and block diagrams in the figures illustrate the architecture, functionality, and operation of some possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The invention can take the form of an entirely hardware embodiment, an entirely software embodiment or an embodiment containing both hardware and software elements. In a preferred embodiment, the invention is implemented in software, which includes, but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the illustrative embodiments has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for providing data to a scheduler, the method comprising:
retrieving a set of profiling data from an executable object file for an application, wherein the set of profiling data is associated with a given process of the application; and
passing the set of profiling data to a scheduler, wherein the scheduler uses the set of profiling data for scheduling the given process for execution by a processor.

2. The computer implemented method of claim 1, further comprising:
storing the set of profiling data as meta-data in the executable object file for the application.

3. The computer implemented method of claim 1, wherein the set of profiling data is generated by a compiler during compile time of the application.

4. The computer implemented method of claim 1, wherein the set of profiling data is generated by a linker during a link phase of building the application.

5. The computer implemented method of claim 4, wherein the linker generates the set of profiling data during the link phase of building the application by making an additional pass on the executable code stored in the text section of an object file.

6. The computer implemented method of claim 1, further comprising:
wherein the set of profiling data includes at least one of a memory usage, an input/output usage, and computational intensity of the given process.

7. The computer implemented method of claim 1, wherein the action of retrieving and passing the set of profiling data is performed by the operating system kernel.

8. The computer implemented method of claim 1, further comprising:
updating the set of profiling data during the life of the process to form an updated set of profiling data.

9. The computer implemented method of claim 8, further comprising:
storing the updated set of profiling data as meta-data in the executable object file for the application.

10. The computer implemented method of claim 8, further comprising:
modifying, by the scheduler, a schedule for the execution of the given process based on the updated set of profiling data.

11. The computer implemented method of claim 8, wherein the set of profiling data is updated based on a set of run time data generated during execution of the given process.

12. An apparatus for providing data to a scheduler, the apparatus comprising:
a bus;
a storage device connected to the bus, wherein the storage device contains computer usable code;
at least one managed device connected to the bus;
a communications unit connected to the bus; and
a processing unit connected to the bus, wherein the processing unit executes the computer usable code to retrieve a set of profiling data from an executable object file for the application, wherein the set of profiling data is associated with a given process of the application; and pass the set of profiling data to a scheduler, wherein the scheduler uses the set of profiling data for scheduling the given process for execution by a processor.

13. The apparatus of claim 12, wherein the processing unit further executes the computer usable code to update the set of profiling data during the life of the process to form an updated set of profiling data.

14. The apparatus of claim 12, wherein the scheduler updates the set of profiling data during the life of the process to form an updated set of profiling data; and wherein the loader stores the updated set of profiling data as meta-data in the executable object file for the application.

15. A computer program product for providing data to a scheduler, the computer program product comprising:
a computer usable medium having computer usable program code tangibly embodied thereon, the computer usable program code comprising:
computer usable program code for retrieving a set of profiling data from an executable object file for the application, wherein the set of profiling data is associated with a given process of the application; and
computer usable program code for passing the set of profiling data to a scheduler, wherein the scheduler uses the set of profiling data for scheduling the given process for execution by a processor.

16. The computer program product of claim 15, further comprising:
computer usable program code for storing the set of profiling data as meta-data in the executable object file for the application.

17. The computer program product of claim 15, further comprising:
computer usable program code for updating the set of profiling data during the life of the process to form an updated set of profiling data.

18. The computer program product of claim 15, further comprising:
computer usable program code for storing the updated set of profiling data as meta-data in the executable object file for the application.

19. A computer implemented method for providing data to a scheduler, the method comprising:
retrieving meta data from an executable object file for an application, wherein the meta data contains data about the application, and wherein the meta data is generated by a linker during a link phase of building the application; and
passing the meta data to a scheduler, wherein the scheduler uses the meta data for scheduling the given process for execution by a processor.

20. The computer implemented method of claim 19, further comprising:
updating the meta data during the life of the process to form an updated meta data.
